(19) United States
(12) Patent Application Publication
(10) Pub. No.: US 2006/0155526 A1
(43) Pub. Date: Jul. 13, 2006

(54) Systems, Devices, & Methods for automating non-deterministic processes

(75) Inventors: Cecilia Castillo, Lebanon, NJ (US); James M. Wilson, Berkeley Heights, NJ (US); Theodore J. Roycraft, Califon, NJ (US)

Correspondence Address: AT&T Corp., Room 2A-207, One AT&T Way, Bedminster, NJ, 07921, US

(73) Assignee: AT&T Corp.

(21) Appl. No.: 11/032,287

(22) Filed: Jan. 10, 2005

(51) Int. Cl. G06F 17/20

(52) U.S. Cl. 704/1

(57) ABSTRACT

Certain exemplary embodiments comprise a method comprising: for a graphical representation of a process, the graphical representation comprising a network comprising a plurality of nodes connected by directional arcs: converting the graphical representation to a context-free grammar notation; for each of the directional arcs, defining at least one function from a plurality of functions, the function dependant on state information of the nodes connected by the arc; and for each of the functions, generating source code.

### CROSS-REFERENCES TO RELATED APPLICATIONS

This application claims priority to, and incorporates by reference herein in its entirety, each of the following pending U.S. patent applications:
Ser. No. 10/826,064 (Attorney Docket No. 2002-0371), filed 16 Apr. 2004;
Ser. No. 10/826,065 (Attorney Docket No. 2002-0418), filed 16 Apr. 2004;
Ser. No. 10/826,062 (Attorney Docket No. 2002-0427), filed 16 Apr. 2004; and
Ser. No. 10/812,999 (Attorney Docket No. 2002-0428), filed 31 Mar. 2004.

### BACKGROUND

Many types of systems can be represented via graphical network illustrations. For example, dialog systems and/or dialog managers, such as those supported by Interactive Voice Response (IVR) systems, are often defined and/or described using call flow diagrams. Once a system is defined, it can be translated into a physical (software) implementation. In some situations, the translation can be difficult and/or error prone as concepts depicted in the call flow often must be interpreted by an implementer. Further, checking and testing that the implementation is faithful to the call flow can be a substantial and/or expensive challenge.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of an information device 2000;

FIG. 3 is a flowchart of an exemplary embodiment of a method 3000; and

FIG. 4 is a block diagram of an exemplary embodiment of a system 4000.

### DETAILED DESCRIPTION

Many types of systems can be represented via graphical network illustrations. For example, dialog systems and/or dialog managers, such as those supported by Interactive Voice Response (IVR) systems, are often defined and/or described using call flow diagrams. Once a system is defined, it can be translated into a physical (software) implementation. In some situations, the translation can be difficult and/or error prone as concepts depicted in the call flow often must be interpreted by an implementer. Further, checking and testing that the implementation is faithful to the call flow can be a substantial and/or expensive challenge.

Certain exemplary embodiments provide a notational scheme, based on Backus Naur Forms (BNFs), that can enable complex graphical designs to be easily represented in equivalent, but concise, augmented grammars. This representation can lay the foundation for graphically represented systems, such as call flows, to be implemented and tested with greater ease and/or accuracy.

The augmented BNF is a BNF that can impart special meanings to certain symbols. It can permit details that are specified in a graphical representation of a callflow to be represented in a BNF network representation. Various classes of operations along with parameter values can be represented by the augmented BNF.

A typical BNF network representation can comprise a sequence of terminal and non-terminal elements connected by binary operations (e.g., “and”, “or”), which can guide the path through the BNF network. A sequence of input tokens can cause the network to be traversed as long as the network accepts (matches) the list of input tokens with the current terminal. Eventually, either a terminal state (final state) will be reached or else a terminal state won't be reached because the sequence of input tokens was not compatible with the BNF network.

In certain exemplary embodiments, the notion of terminals can be extended. Normally, terminals are fixed entities such as “dog”, “cat”, etc. The notion of terminals can be extended by first creating a set of classes of terminals. Within each class, different terminals of that class can be defined by name. For certain implementations, classes such as “in”, “out”, numeric and string operators, “tag”, “def”, and/or “func” can be chosen. The “in” classes can be used to match input tokens and/or to execute a particular generated function when that input terminal name is matched by an input token; “out” classes can be used to represent “output” actions (such as issuing a prompt) when that terminal is reached; “tag” terminals can be executed as they are passed through and are generally used to mark progress through the network typically for logging and tracing; operator classes can test or modify the values of state variables and/or change the flow based on the operator and the values it operates on. If a test is ‘true’, it can be passed to the next state; if it is false, the path can be blocked. State variables can comprise a set of string or numeric variables associated with each state in the network. As the network is glided through, states passed through can inherit the values of the state variables from the previous state but have their own copy. State variables that are modified by a downstream state don't affect state variables that are upstream in the network. The “func” terminals cause the named function to be executed as that terminal is passed through. That function returns a value that either blocks passage through that terminal or permits passage depending on the value returned.

Normally, to pass through a terminal, an input token must match it. In certain exemplary embodiments, the only terminal that must be matched by an input token is the “in” class token. All others simply can be passed through to the next terminal as long as the actions performed for that particular terminal permit passage through it. For those terminals other than the “in” class, as they are passed through, certain actions can be implied based on the type of class that is passed through. It is also possible for actions specific to that particular augmented terminal to take place. Because it is possible that there are multiple valid paths out of a particular state (i.e., the network is nondeterministic), a “look ahead” in the network can be performed until a blocking state is encountered and/or a successful finish at a final state occurs. If a blocking path is encountered, backtracking to the previous state can occur, followed by checking the next valid path out of that state. This can be done recursively until a path is eventually found that ends up at a valid final state and/or a determination occurs that there is no valid path to the final state. Since backtracking sometimes can occur, the set of state variables can be stored on a stack. As a new state is performed, a copy of all the state variables can be made and the set of pushed them on the stack. If backtracking occurs, the last state can be popped off the stack to restore a valid state to the state backtracked to.

Thus, non-terminal nodes, i.e. rules, may also be present among the terminal nodes. The following BNF would be legal.
A=abcd;
B=xyzA;

Also, right recursive BNFs are also legal. Something like the following would be permitted:
A=(a|bA);

What follows is an example of how this can be used. In certain exemplary embodiments, C++ code can be automatically generated from the augmented BNF. For each specific terminal, a template C++ function can be generated for that terminal. Also, for each class of terminal, a common function can be created for that class. When the application is running, as passage occurs from terminal to terminal, the common function for that terminal class can be executed as well as the specific function for that particular terminal. For example, if passage occurs through the output terminal “giraffe”, then the functions “out_common( . . . )” as well as “out_giraffe( . . . )” can be executed. In other words, the programmer can fill in the common functions with actions that are common to all terminals of that class and if it is necessary and/or desired, the programmer can fill in the specific generated functions with code specific to that terminal, in this case “giraffe”.

The text in the following paragraph illustrates an augmented BNF that implements a loop that can initialize a variable (‘count’ in this case), and decrements it in a loop. As long as the value of ‘count’ is greater than zero, the loop can continue. When the value of ‘count’ is zero, the loop can terminate. This loop BNF was created by hand but it could have been created as a Visio diagram and converted to a BNF.

<start> = go\in count\set6 <_start1>;
<_start1> = put\out (count\le0 done\out | count\gt0 count\sub1
<_start1>);

The text in the following paragraph illustrates the power of augmented BNFs by showing how square roots can be computed using the Newton-Raphson method using augmented BNFs:

<start> = go\in xinit\@setxsquared <_start1>;
<_start1> = x2\@setxinit x2\@mulx2 x2\@subxsquared x2\div2.0
x2\@divxinit xnew\@setxinit xnew\@subx2

xdiff\@setxinit xdiff\@subxnew xinit\@setxnew

(xdiff\gt.00001 enroute\out <_start1> | def\def done\in done\out).

It might be worthwhile to note that what we are calling augmented BNFs are BNFs that are modified in a couple of important ways. Note that BNF grammars are equivalent to finite state machine (FSM) networks and one might find it more comfortable talking in the terminology of FSMs. Conventional FSMs can be directed graphs, i.e., states (nodes) connected by directional arcs. Each arc between states can have a label. There can be a start node in the network and one or more final states. A sequence of tokens can be fed to the FSM and the network can be traversed between the start node and final node if you can find a sequence of labels on arcs that matches the input token sequence. For example, if the network looks like this:

<start> = the (dog | cat) chased the (mouse | spider);

the following sequences can successfully traverse the network in a conventional BNF:
the cat chased the spider
the dog chased the spider
the cat chased the mouse
   but the following do not match:
the mouse chased the spider
the cat chased the black widow spider
the cat chased the spider web

That is the behavior of a conventional BNF. We can augment this kind of BNF in the following ways:
semantics can be given to labels between nodes with different behaviors exhibited while traversing an arc depending on the label type for that arc;
a set of state variables can be assigned to each node and the values of the variables may be modified, depending on the nature of the arc label, when proceeding from state to state. State variables can be maintained for each state visited while traversing the network with multiple sets of variables can be maintained for each state that is visited multiple times (such as in a loop);
even though the network is a directed graph, there can be situations when we can back up over one or more states while we are in the process of traversing the network; and
in our network, part of the process of “compiling” the network can be to generate source code of an object oriented programming language (we can generate C++ code but any object oriented language such as Java could be used) such that one function for each particular arc is generated and a common function for each arc type is generated. The idea is that as the network is traversed, each function corresponding to the traversed arc can be executed and the function corresponding to the arc type also can be executed. The developer may modify any of these generated functions. This gives the developer an opportunity to customize the actions that are taken as each arc is traversed. The common function for the arc type can allow the developer to determine the behavior as each arc type is traversed. Generated functions can have full access to all state variables—the ones for the current state plus the state variables for all previously visited states. One feature of the generated functions can be that, depending on the value returned by the function, the developer may cause passage across that arc to be blocked.

Arcs can be segregated into types. The only type arc that expects an input token is an input arc. The other arcs are traversed or not depending on the true or falseness of expressions involving state variables or by values returned by the underlying functions, under control of the programmer.

We defined five arc types but this list can be expanded or changed (note that our convention for specifying an arc type is to supply a particular suffix to each named label. We can use suffixes \in, \out, \tag, \func, and \def). Our defined arc types and their behaviors can be as follows:
\in—input label. This type arc can be traversed when an input token matches the label on the arc, e.g., if the next input token is ‘bird’, then the label ‘bird\in’ will match this input token.
\out—output label. This type arc can be always traversed and usually can perform some action that is determined by the specific function for that arc or the common function for that arc type.
\tag—tag label. Usually used to provide information (logging, debugging, or otherwise) about progress through the network.
\func—function label. A function with the name of the label can be generated and executed when this arc is traversed.
\def—default label. If no other label is matched which would pass control from one node to another, the default arc can be taken if there is a default arc leading from that node. This gives a node with a default behavior.

In addition, there can be other suffixes that manipulate and test the values of state variables (which are represented as labels). For example, ‘cntr\set5’ can set the state variable ‘cntr’ to the value ‘5’; ‘cntr\ge4’ can be an arc that is ‘true’ if state variable is greater than or equal to 4. The other possible state variable suffixes are:
xyz\add‘nnn’ nnn is added to state variable xyz—always true
xyz\eq‘nnn’ true if xyz equals nnn, otherwise false
xyz\ge‘nnn’ true if xyz is greater than or equal to nnn, otherwise false
xyz\gt‘nnn’ true if xyz is greater than nnn, otherwise false
xyz\le‘nnn’ true if xyz is less than or equal to nnn, otherwise false
xyz\lt‘nnn’ true if xyz is less than nnn, otherwise false
xyz\ne‘nnn’ true if xyz is not equal to nnn, otherwise false
xyz\set‘nnn’ set xyz to nnn, always true
xyz\sub‘nnn’ subtract nnn from xyz and store in xyz; always true
xyz\mul‘nnn’ multiply nnn from xyz and store in xyz, always true
xyz\div‘nnn’ divide xyz by nnn and store in xyz, always true
xyz\abs take absolute value of xyz; always true

Indirections are also permitted, i.e., xyz\mul@abc means multiply the value of the state variable ‘abc’ by xyz and store in xyz.

Here are some examples:

1) <start> = one\in (two\in three\in | three\in | two\in four\in);

The following input token sequences would match this network . . .
one two three
one three
one two four

No other sequences would match. In addition, for each label, the corresponding function can be executed and the common \in function also can be executed. Look at what happens if the input sequence “one two four” is applied. First the ‘one’ is matched. Then the first ‘two’ is matched—the ‘two’ that goes with the ‘three’ in the network. Since ‘four’ appears next, we can back up in the network and see if there is another match for a ‘two’ after the ‘one’. There is another ‘two’ and this path can be tried.

2) <_start1> = ctr\set0 one\in ctr\add1 (ctr\eq1 ctr\set8 two\in
prompt1\out | ctr\eq1 ctr\set9 three\in prompt2\out);

This does not necessarily do anything really useful but illustrates manipulation of state variables. If the input sequence is “one three”, then the following sequence of arcs ultimately can be traversed:

“ctr\set0 one\in ctr\add1 ctr\eq1 ctr\set9 three\in prompt2\out” and the value of ‘ctr’ upon exiting will be 9. Notice that in order to see that we don't match the ‘two\in’ arc, we have to pass through these arcs “ctr\eq1 ctr\set8 two\in” before determining that this is a dead end path and we have to roll back up and try the next path. This illustrates how the state variables, in this case ‘ctr’, has a value for each state visited, which is preserved in case we have to back up and restore the state to go on from there.

3) <start> = go\in count\set6 <_start1>;

<_start1> = put\out (count\le0 done\out | count\gt0 count\sub1
<_start1>);

This accepts ‘go’ and then outputs 6 ‘put’ outputs and finally ‘done’.

Thus, a system and/or process can be graphically-representable as a network comprising a plurality of nodes (states) connected by directional arcs. The graphical representation can be in the form of a Visio diagram and/or a finite state machine network, which can be described and/or converted to, a context free grammar notation such as a BNF. Via an augmented BNF, for each node, information can be defined, described, modified, and/or interpreted. Depending on the information of the associated nodes, for each arc, functions can be defined; described; modified; interpreted; and/or generated into source code of an object-oriented programming language.

Certain exemplary embodiments provide a method comprising: for a graphical representation of a process, the graphical representation comprising a network comprising a plurality of nodes connected by directional arcs: converting the graphical representation to a context-free grammar notation; for each of the directional arcs, defining at least one function from a plurality of functions, the function dependant on state information of the nodes connected by the arc; and for each of the functions, generating source code.

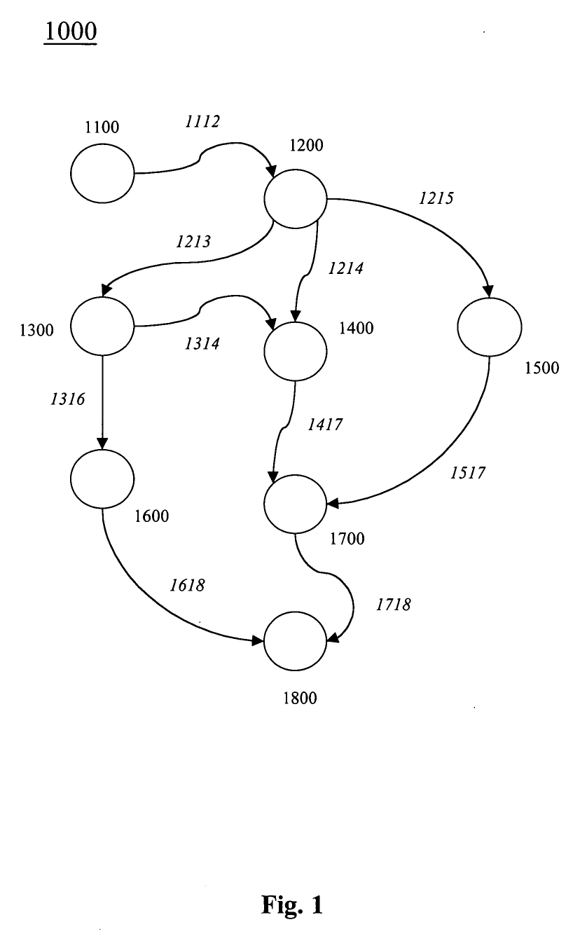

FIG. 1 is a block diagram of an exemplary embodiment of a system 1000, which can comprise a plurality of nodes, 1100, 1200, 1300, 1400, 1500, 1600, 1700, 1800, certain pairs of which can be coupled by directional arcs, 1112, 1213, 1214, 1215, 1314, 1316, 1417, 1517, 1618, 1718.

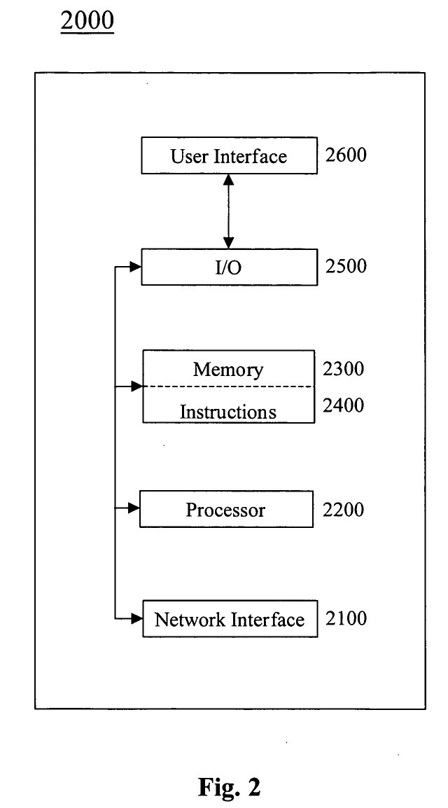

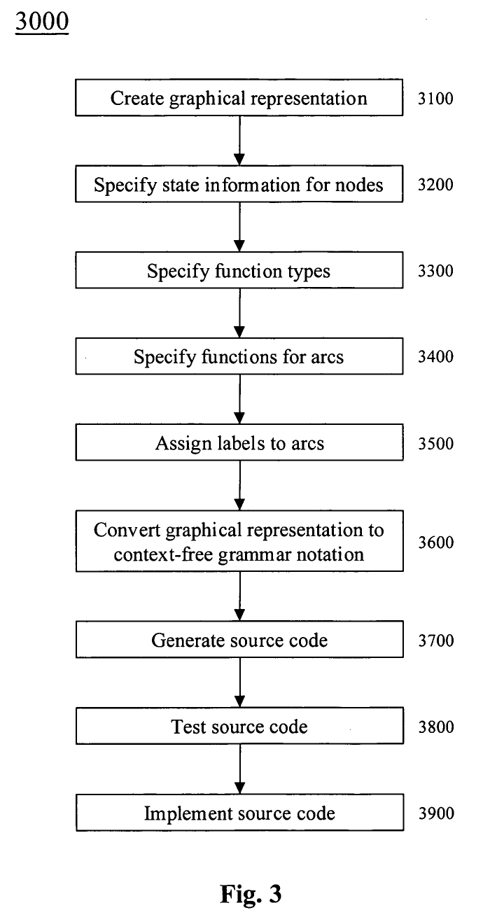

FIG. 2 is a block diagram of an exemplary embodiment of an information device 2000, which in certain operative embodiments can perform, for example, one or more activities of method 3000 of FIG. 3. Information device 2000 can comprise any of numerous well-known components, such as for example, one or more network interfaces 2100, one or more processors 2200, one or more memories 2300 containing instructions 2400, one or more input/output (I/O) devices 2500, and/or one or more user interfaces 2600 coupled to I/O device 2500, etc.

In certain exemplary embodiments, via one or more user interfaces 2600, such as a graphical user interface, a user can view a rendering of a graphical representation of a process, the graphical representation comprising a network comprising a plurality of nodes connected by directional arcs.

FIG. 3 is a flowchart of an exemplary embodiment of a method 3000. At activity 3100, a graphical representation of a process can be created, the graphical representation comprising a network comprising a plurality of nodes connected by directional arcs. At activity 3200, state information for various nodes of the network can be specified, defined, and/or assigned. At activity 3300, function types can be specified, defined, and/or assigned. At activity 3400, function types and/or functions can be specified, defined, and/or assigned for one or more directional arcs of the network. At activity 3500, labels can be specified, defined, and/or assigned to one or more directional arcs of the network. At activity 3600, the graphical representation can be converted to a context-free grammar notation. At activity 3700, source code can be generated from the context-free grammar notation. The source code can be associated with a object-oriented programming language. At activity 3800, the source code can be tested. At activity 3900, the source code can be translated, compiled, interpreted, and/or implemented.

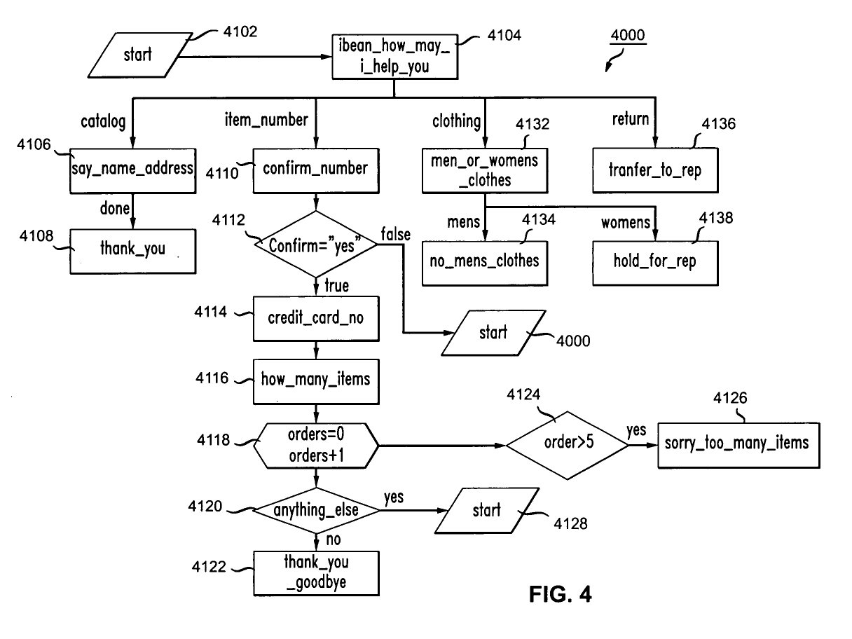

FIG. 4 is a graphical representation 4000 of an exemplary embodiment of a call-flow (i.e., dialog management process and/or voice response process) for a mail order company. The graphical representation 4000 illustrates how a phone customer could accomplish one of four tasks: (1) request a catalog; (2) buy by item by item number; (3) inquire about clothing; or (4) request a return. During the course of the conversation with the customer, the dialog progresses through graphical representation 4000 guided by the customer's utterances and the spoken dialog system responds to the customer with prompts.

Each state (node) in graphical representation 4000 can have one or more state variables associated with the state. These variables can have string and/or numeric values and can be created, tested, and/or changed as the dialog progresses through graphical representation 4000 and the values of these variables can affect the flow.

The shapes of the boxes on the call-flow can have special meanings. For example, the parallelograms can refer to a starting state. The rectangles can represent prompts to customers. The diamonds can indicate state variable boolean tests, and the hexagons can reflect state variable manipulation

Lines with arrows (i.e., directional arcs) can show possible transitions between states, and each arrow is labeled by what is determined to be the customer's intent. So, for example, after the starting point 4102, the first prompt is “How may I help you?” 4104. In response, the customer may say “I'd like to order item number B453 from your catalog”. Other software in the system determines the customer's intent from this response. This is typically determined from a dialog manager module in the spoken dialog system. In this example, the intent is determined to be “item_number” and thus this path in graphical representation 4000 is followed. The prompt asks the user to confirm the item number 4110 and if the confirmation is affirmative (“yes”) 4112, then the prompt asks for a credit card number 4114 and the number of items 4116. In this call-flow, the system increments the number of items on order 4118 and determine whether a threshold has been reached 4124. If yes, then the system prompts that too many items have been ordered 4126. If the threshold is not reaches, then system asks if the customer would like anything else 4120 and if yes, it starts over 4128. If no, then the prompt says good bye and thank you 4122.

If the user at stage 4104 asks for clothing, the system asks for clothing for men or women cloths 4132. If the clothing is for men, the system states that they have no mens clothing 4134. If the response is that cloths for women are desired, then the prompt holds for a representative 4138. If the user responds at stage 4104 that they want to return an item, the system tells the user that they will be transferred to a representative 4136.

If the user's utterance indicates a desire for a catalog, the prompt 4106 asks for the customer to say their name and address. Once that is received, the system says “thank you” 4108 and completes the process.

In this manner, the spoken dialog system steps through the call-flow. It can be appreciated that there are many variations of call-flows depending on the type of application. Graphical representation 4000 provides only an example for the purpose of illustration. Graphical representation 4000 is a convenient way for the call-flow designer to view the call-flow but is not necessarily a suitable form for the runtime system to use. Likewise, graphical representation 4000 is not necessarily suitable for testing and/or validating dialogs associated with run-time verification and/or system testing.

When the following terms are used substantively herein, the accompanying definitions apply:
access—to approach, enter, exit, communicate with, or make use of.
activity—an action, act, step, and/or process or portion thereof.
adapted to—made suitable or fit for a specific use or situation.
apparatus—an appliance or device for a particular purpose
assign—to attribute.
associate—to relate, map, and/or join together.
augmented BNF—a BNF that imparts special meanings to certain symbols.
automate—to cause to act or operate in a manner essentially independent of external and/or manual influence or control. For example, a computer program can assume the control of a previously manually-controlled process, thereby freeing the former (human) operator for other tasks.
automatically—acting or operating in a manner essentially independent of external influence or control. For example, an automatic light switch can turn on upon “seeing” a person in its view, without the person manually operating the light switch.
BNF (Backus-Naur Form)—a formal mathematical way to define the grammar of a language, so that there is no disagreement or ambiguity as to what is allowed and what is not.
can—is capable of, in at least some embodiments.
change—to cause to be different.
comprising—including but not limited to.
connect—to join together.
couplable—capable of being joined, connected, and/or linked together.
data—distinct pieces of information, usually formatted in a special or predetermined way and/or organized to express concepts.
define—to precisely and/or distinctly describe and/or specify.
dependent—relying upon and/or contingent upon.
desired—indicated, expressed, and/or requested.
determine—ascertain, obtain, and/or calculate.
directional arc—any graphical symbol, such as a line and/or curve with an arrowhead at one end, denoting a state transition.
directly upstream—an immediately adjacent node located at a non-arrowed end of an arc coupled to a node.
finite state—relating to an entity, such as a machine and/or process, that can be in one of a finite number of states. In certain conditions, the entity can switch to another state depending on a transition function.
function—a procedure and/or sub-procedure.
function type—a class of functions.
generate—to create or produce.
graphical—of or relating to a pictorial image.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions adapted to perform a particular operation or function.
label—an identifier of an arc.
machine readable medium—a physical structure from which a machine can obtain data and/or information. Examples include a memory, punch cards, etc.
maintain—stored and/or preserved.
match—to resemble, harmonize with, find a counterpart to, and/or fit together with.
may—is allowed to, in at least some embodiments.
memory—a device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory can be coupled to a processor and can store instructions adapted to be executed by processor according to an embodiment disclosed herein.
method—a process, procedure, and/or collection of related activities for accomplishing something.
modify—to change.
neighbor—a router within a short distance or interval in space or time from a given router and with no intervening routers.
network—a functionally-coupled plurality of nodes.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
node—a graphical symbol denoting a state.
non-deterministic—a computation, algorithm, and/or process, and/or a stage thereof, in which there is more than one allowed step and/or more than one result at certain times. One way to implement a nondeterministic method is using backtracking; another is to explore (all) possible solutions in parallel.
object-oriented—a class of programming languages and techniques based on the concept of an “object”, which is a data structure (abstract data type), encapsulated with a set of routines, called “methods”, which operate on the data. Typically, operations on the data can only be performed via these methods, which are common to all objects that are instances of a particular “class”. Thus the interface to objects is well defined, and allows the code implementing the methods to be changed so long as the interface remains the same.
operative—being in effect; operating.
plurality—the state of being plural and/or more than one.
predetermined—established in advance.
process—a series of actions, changes, and/or functions bringing about a result.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
programming language—an artificial language used to write instructions that can be translated into machine language and then executed by a computer.
provide—to make available; to supply; to prepare.
receive—to take, obtain, and/or acquire.
representation—a visual and/or tangible rendering.
reverse direction—a traversal of an arc oppositely from the directional arrow of the arc.
sequence—an ordered series.
set—a related plurality.
source code—human-readable code that can be converted to object code or machine code that a computer can run.
state—a condition of an entity at a given time.
state information—data at least partially defining a state.
store—to place, hold, and/or retain data, typically in a memory.
substantially—to a great extent or degree.
system—a collection of mechanisms, devices, data, and/or instructions, the collection designed to perform one or more specific functions.
telecommunications—the science and technology of communication at a distance by electronic transmission of impulses.
terminal node—a node that terminates a process.
token—a basic, grammatically indivisible unit of a language such as a keyword, operator, and/or identifier.
transmit—to send.
traverse—to move along an arc and/or complete a function represented by an arc.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
visit—an occupation of a state.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A method, comprising:
for a graphical representation of a non-deterministic finite state process, the graphical representation comprising a network comprising a plurality of nodes connected by directional arcs:
converting the graphical representation to a context-free grammar notation;
for each of the directional arcs, defining at least one function from a plurality of functions, the function dependant on state information of the nodes connected by the arc; and
for each of the functions, generating source code in an object-oriented programming language.

2. The method of claim 1, further comprising:
defining a function type corresponding to the at least one function from the plurality of functions.

3. The method of claim 1, further comprising:
assigning one of a plurality of labels to each of the directional arcs.

4. The method of claim 1, further comprising:
modifying a function type of a selected arc.

5. The method of claim 1, further comprising:
modifying the at least one function of a selected arc.

6. The method of claim 1, further comprising:
defining state information for a node from the plurality of nodes.

7. The method of claim 1, further comprising:
defining state information for each node from the plurality of nodes.

8. The method of claim 1, further comprising:
modifying state information for a node from the plurality of nodes.

9. The method of claim 1, further comprising:
modifying state information for a node from the plurality of nodes when an arc coupled to that node is traversed.

10. The method of claim 1, wherein:
the context-free grammar notation is an augmented BNF.

11. The method of claim 1, wherein:
the plurality of nodes comprises a plurality of non-terminal nodes.

12. The method of claim 1, wherein:
each of the directional arcs corresponds to a function type.

13. The method of claim 1, wherein:
each of the functions has access to state information for all previously visited nodes.

14. The method of claim 1, wherein:
the network is adapted to receive a sequence of tokens.

15. The method of claim 1, wherein:
the network is adapted to be traversed if a received sequence of tokens match labels assigned to a connected series of arcs.

16. The method of claim 1, wherein:
the plurality of directional arcs comprises a plurality of input arcs, each input arc adapted to be traversed if a token presented to a node directly upstream of that input arc matches a label of that input arc.

17. The method of claim 1, wherein:
for each arc, the corresponding function is adapted to be run if that arc is traversed.

18. The method of claim 1, wherein:
for a predetermined node from the plurality of nodes, multiple sets of state information are adapted to be maintained, each set corresponding to a visit to that predetermined node.

19. The method of claim 1, wherein:
a predetermined directional arc from the plurality of directional arcs is adapted to be traversed in a reverse direction.

20. A machine readable medium storing instructions for activities comprising:
for a graphical representation of a non-deterministic finite state process as a network comprising a plurality of nodes connected by directional arcs:
converting the graphical representation to a context-free grammar notation;
for each of the directional arcs, defining at least one function from a plurality of functions, the function depending on state information of the nodes linked by the arc; and
for each of the functions, generating executable source code in an object-oriented programming language.
